(19) United States
(12) Patent Application Publication
(10) Pub. No.: US 2024/0311685 A1
(43) Pub. Date: Sep. 19, 2024

(54) APPARATUS AND METHODS TO PROVIDE INFORMATION SECURITY FOR A MACHINE LEANRING (ML) MODEL BY GENERATING AN EXPLANATION FOR THE ML MODEL WITHOUT ACCESSING THE ML MODEL

(71) Applicant: Fiddler Labs, Inc., Palo Alto, CA (US)

(72) Inventors: Kaivalya RAWAL, Philadelphia, PA (US); Amit PAKA, Menlo Park, CA (US); Krishna GADE, Sunnyvale, CA (US); Krishnaram KENTHAPADI, Sunnyvale, CA (US)

(21) Appl. No.: 18/185,088

(22) Filed: Mar. 16, 2023

(51) Int. Cl. G06N 20/00

(52) U.S. Cl. CPC G06N 20/00

(57) ABSTRACT

In an embodiment, a method includes receiving, via a processor of a first compute device, a representation of a set of inputs and a set of outputs that were generated by inputting the set of inputs into a machine learning (ML) model by a set of compute devices not including the first compute device to generate the set of outputs. The method further includes receiving, via the processor, a request for a machine learning (ML) explanation associated with the ML model and at least one explicand. The method further includes generating, via the processor and without using the ML model, a representation of the ML explanation based on the at least one explicand, the set of inputs, and the set of outputs.

### FIELD

One or more embodiments are related to an apparatus and method to provide information security for a machine learning (ML) model by generating an explanation for the ML model without having access to the ML model.

### BACKGROUND

Explaining the predictions made by a machine learning (ML) model can be desirable in many real-world applications because such explanations can be used (e.g., by customer-facing teams) to understand the rationale behind the ML model's predictions, to debug the ML model's predictions, to comply with regulations and legal requirements, to provide transparency and help build trust in the model itself, and/or the like. Known techniques to generate post-hoc explanations for an opaque (“black-box”) model typically require access to the model, which can sometimes be unavailable due to business confidentiality, data privacy, technical feasibility, technical viability, and/or the like. Therefore, in light of the aforementioned, it can be desirable to generate explanations for ML models without requiring access to or ingestion of the model and/or model prediction artifacts.

### SUMMARY

In an embodiment, a method includes receiving, via a processor of a first compute device, a representation of a set of inputs and a set of outputs that were generated by inputting the set of inputs into a machine learning (ML) model by a set of compute devices not including the first compute device to generate the set of outputs. The method further includes receiving, via the processor, a request for a machine learning (ML) explanation associated with the ML model and at least one explicand. The method further includes generating, via the processor and without using the ML model, a representation of the ML explanation based on the at least one explicand, the set of inputs, and the set of outputs.

In an embodiment, an apparatus comprises a memory and a processor operatively coupled to the memory. The processor is configured to receive a set of inputs and a set of outputs from a remote compute device. The set of inputs were input to a machine learning (ML) model to generate the set of outputs. The processor is further configured to receive a representation of an explicand. The processor is further configured to generate, without using the ML model, a machine learning (ML) explanation associated with the ML model and the explicand based on the set of inputs, the set of outputs, the explicand, and not other explicands.

In an embodiment, a machine-readable medium storing code representing instructions to be executed by a processor. The code comprises code to cause the processor to receive a set of inputs and a set of outputs from a remote compute device. The set of inputs were input to a machine learning (ML) model to generate the set of outputs. The code further comprises code to cause the processor to receive a representation of a plurality of explicands. The code further comprises code to cause the processor to generate, without using the ML model, a machine learning (ML) explanation associated with the ML model and the plurality of explicands based on the set of inputs, the set of outputs, and the plurality of explicands.

### BRIEF DESCRIPTION OF THE DRAWINGS

FIG. 1 shows a block diagram of a system to generate an explanation for a ML model without accessing the ML model, according to an embodiment.

FIG. 2 shows a flowchart of a method to generate an ML explanation for one or more explicands and an ML model without using the ML model, according to an embodiment.

FIG. 3 shows a flowchart of a method to generate an ML explanation for a single explicand and an ML model without using the ML model, according to an embodiment.

FIG. 4 shows a flowchart of a method to generate an ML explanation for multiple explicands and a ML model without using the ML model, according to an embodiment.

### DETAILED DESCRIPTION

Machine learning (ML) explanations for ML models may not always be feasible to generate in real world settings. Post-hoc explanation methods are sometimes used when generating explanations for such models are found to be unfeasible. Even among post-hoc explanation methods, however, some explanation types are only applicable to certain models (e.g., Gini importance for random forests). When the model type is unknown, model-agnostic post-hoc explanation methods have been used, such as local interpretable model-agnostic (LIME) or Shapley Additive explanations (SHAP). Even such methods, however, are not used if query access to the model is unavailable. Therefore, no known ML explanation technique exists that can produce model explanations without having to query the model and that can generate predictions on new synthetically generated data points.

As such, some implementations described herein are related to generating model explanations without having to fetch model predictions on any new data points. The explanations each can provide additional details on how the ML model calculated an output for a given input (i.e., the explicand). The explanation can be generated without access to the ML model; said differently, the explanation can be generated without accessing parameters of the ML model, weights of the ML model, and/or the like. In some implementations, explanations can be provided for ML models that are in production (e.g., after the model has been developed and is deployed), and not in development/training. In some implementations, explanations can be provided for ML models that are in production or in development/training.

Some implementations are related to accessing only the set of inputs issued to (e.g., input to) an ML model and corresponding prediction outputs, which can be readily obtained from, for example, the prediction logs associated with a deployed ML model, by querying the ML model directly, and/or the like. Many ML model users are not willing to share an ML model, but are much more willing to share inputs and outputs produced by the model (e.g., during deployment of the model).

In some implementations, sampling in the input space of a ML model can be replaced with approximate nearest neighbor search performed on a sufficiently large prediction log. In some instances, a prediction log refers to a list of inputs and an associated list of outputs, where the list of outputs was generated by an ML model (e.g., a trained ML model) in response to being fed the list of inputs.

### SHAP

Some known techniques for model agnostic Kernel Shapley Additive exPlanations (SHAP) attribution based post-hoc explanations used multiple ‘predict( )’ function calls. Kernel SHAP works by sampling coalitions, converting each sampled coalition into a synthetic data point in the input space, calling the ‘predict( )’ function on the generated data point to generate a predicted output using the ML model, and observing the result; doing this repeatedly can produce attributions for each feature of the explicand. Kernal SHAP, however, is not without its undesirable attributes. For example, model ingestion is used to access the predict function. Moreover, SHAP can be expensive, where each point explanation may use a very large (exponential in the number of features) number of ‘predict( )’ calls to generate SHAP feature attributions. Moreover, cheaper surrogate models can be susceptible to multicollinearity, leading to wildly different SHAP attributions for differing random seeds. Moreover, latencies can be higher than desirable, as each point-explanation can use 100,000+ predict calls.

In view of the aforementioned, some implementations are related to precomputing and storing coalitions and their corresponding attributions in a database (DB). As such, DB lookups can replace ‘predict( )’ calls for each point-explanation. To further reduce storage and latency, k-nearest neighbors (KNN) regressors can be used to predict feature attributions directly instead of computing feature contributions from example predictions stored in the DB.

Instead of sampling new coalitions for each explicand, some implementations are related to precomputing model predictions for uniformly distributed coalitions. A reference data distribution can be used to conjecture what the distribution of the explicand(s) could look like. Based on this conjecture, a compute device can predict where the sampled coalitions might lie. These predictions can then be used to generate synthetic input points. Instead of ingesting the model, the outputs for these synthetic data points are used.

When faced with a new production event for which feature attributions are to be generated (i.e., an explicand(s)), the predictions from among the supposed synthetic inputs that would and/or could have fed to the model can be used to estimate the feature attributions. This changes the notion of random sampling, and introduces a biased estimate of SHAP attributions in its place. Thus, for example, 100,000 ‘predict( )’ function calls with 10,000 DB lookups can be replaced, thereby reducing latency.

Kernel SHAP attributions can be thought of as being produced by a mapping from a collection of example inputs (e.g., which are synthetically generated according to the sampled coalitions) to a single point-explanation. This can be represented by a non-parametric kernel method. Instead of using an ingested model artifact, production events (moderate load, e.g., Brex) can be fit using a linear regression/KNN regressor (per feature/attribution/coefficient) that predicts feature attributions, even during a time when a server is not expressing queries (e.g., at night, during maintenance, etc.). Given an explicand and a user trying to access a point-explanation for the new product event the following day, various linear KNN regressors can be called to surface attributions for each feature with minimal latency. In some instances, a user can navigate to a point explanation, instantly (e.g., in real time, at machine speed, etc.) view regressor approximations of feature attributions, and, if the point merits further detailed analysis, only then try to run a full-fledged method (e.g., SHAP) to get exact values. Some implementations also include generating confidence scores and/or errors bars for the produced attributions that indicate the how well the approximations are predicted to match the exact values.

### LIME

Local interpretable model-agnostic (LIME) is a known technique that can sample ‘n’ points in the neighborhood of an explicand (sampling in input space), and fetch model predictions using the generated samples using model artifacts. The model predictions are then used to train a model to generate explanations. Some implementations discussed herein, however, find the ‘n’ nearest neighbors for an explicand from a prediction log instead of sampling from input space. Thereafter, model predictions are fetched for the nearest neighbor points from the prediction log (and without using the model artifact). Those model predictions are then used to train a model to generate explanations.

### Counterfactual Explanations (CFE)/Recourse

CFE is a known technique that can sample a point in the neighborhood of an explicand. Model predictions can be fetched for the sampled point using predictions from the model artifact. The prediction probability for the sampled point is then examined: if the prediction has changed, the explanation is the sampled point; if the predication probability has changed in the right/desired direction, the explicand is the sampled point; if the prediction probability has changed in the wrong/undesired direction, a point is re-sampled in the neighborhood of the explicand.

In contrast, some implementations discussed herein, however, search for neighbor of the explicand. Model predictions for this point are obtained using a prediction log and not the model artifact. The prediction probability for this point is then examined: if the prediction has changed, the explanation is the sampled point; if the predication probability has changed in the right/desired direction, the explicand is the sampled point; if the prediction probability has changed in the wrong/undesired direction, a point is re-sampled in the neighborhood of the explicand.

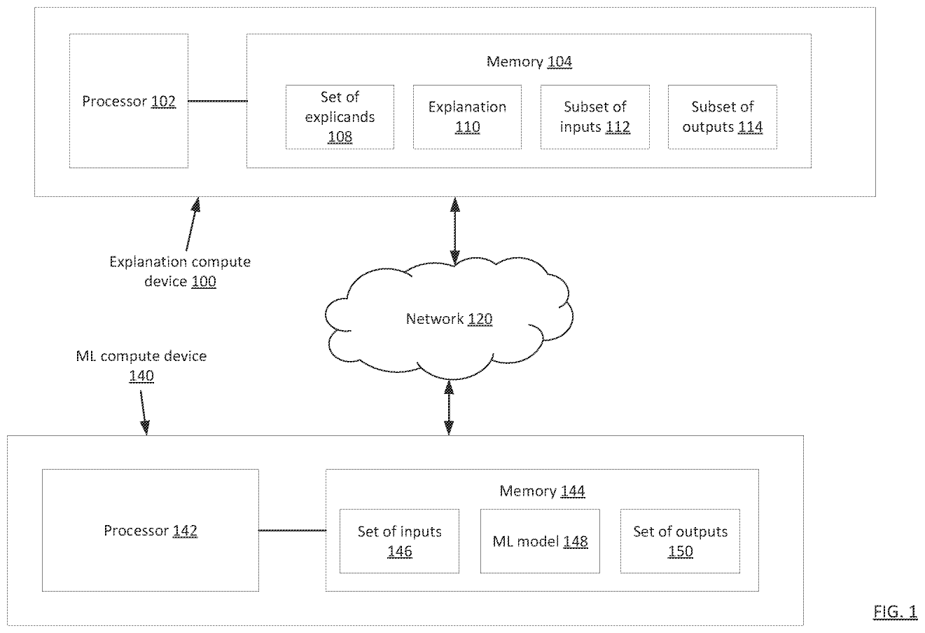

FIG. 1 shows a block diagram of a system to generate an explanation for a ML model without accessing the ML model, according to an embodiment. FIG. 1 includes an explanation compute device 100 and an ML compute device 140. The explanation compute device 100 is communicably coupled to the ML compute device 140 via a network 120.

The network 120 can be any suitable communications network for transferring data, operating over public and/or private networks. For example, the network 120 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 120 can be a wireless network such as, for example, a Wi-Fi or wireless local area network (“WLAN”), a wireless wide area network (“WWAN”), and/or a cellular network. In other instances, the network 120 can be a wired network such as, for example, an Ethernet network, a digital subscription line (“DSL”) network, a broadband network, and/or a fiber-optic network. In some instances, the network can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 120 can be encrypted or unencrypted. In some instances, the communication network 120 can include multiple networks or subnetworks operatively coupled to one another by, for example, network bridges, routers, switches, gateways and/or the like (not shown).

The ML compute device 140 includes a processor 142 operatively coupled to a memory 144 (e.g., via a system bus). The ML compute device 140 can be any type of device, such as a server, desktop, laptop, mobile device, internet of things device, and/or the like.

The processor 142 of ML compute device 140 can be, for example, a hardware based integrated circuit (IC), or any other suitable processing device configured to run and/or execute a set of instructions or code. For example, the processor 142 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 142 can be configured to run any of the methods and/or portions of methods discussed herein.

The memory 144 of ML compute device 140 can be, for example, a random-access memory (RAM), a memory buffer, a hard drive, a read-only memory (ROM), an erasable programmable read-only memory (EPROM), and/or the like. In some instances, the memory 144 can store, for example, one or more software programs and/or code that can include instructions to cause the processor 142 to perform one or more processes, functions, and/or the like. In some implementations, the memory 144 can include extendable storage units that can be added and used incrementally. In some implementations, the memory 144 can be a portable memory (e.g., a flash drive, a portable hard disk, and/or the like) that can be operatively coupled to the processor 142. In some instances, the memory 144 can be remotely operatively coupled with a compute device (not shown); for example, a remote database device can serve as a memory and be operatively coupled to ML compute device 140.

The memory 144 can store a representation of a set of inputs 146, an ML model 148, and a set of outputs 150. The set of inputs 146 can be inputs provided into the ML model 148 to generate the set of outputs 150.

The ML model 148 can be any type of machine learning model. In some implementations, ML model 148 is a neural network, a decision tree, a random forest, a Bayesian classifier, a reinforcement learning classifier and/or any other suitable ML model. In some implementations, ML model 148 is a trained ML model (e.g., at ML compute device 140, at a compute device not shown in FIG. 1, etc.). ML model 148 can be configured (e.g., trained) to complete any machine learning task, such as regression, classification, clustering, transcriptions, translation, anomaly detection, synthetic, sampling, estimation of probability density, estimation of probability mass function, similarity matching, co-occurrence grouping, causal modeling, link profiling, data gathering, data preprocessing, exploratory data analysis, feature engineering, training machine learning models, model and/or algorithm selection, testing and matching, model monitoring, model retraining, and/or the like.

The set of inputs 146 can be any type of input that can be input into ML model 148 to generate set of outputs 150. For example, the set of inputs 146 can include representations of text, images, video, audio, and/or the like. The set of outputs 150 can be output(s) produced by ML model 148 in response to inputting set of inputs 146. For example, the set of outputs 150 can include representations of text, images, video, audio, and/or the like.

In some implementations, ML model 148 is only accessible by a predetermined and limited group of users, user accounts, compute devices, and/or the like (e.g., only software engineers at a company, only users with a security clearance, only users of a certain citizenship, only computers with predetermined software already installed, only user accounts with certain privileges, etc.). This can help to maintain confidentiality and privacy for ML model 148. Reasons ML model 148 may have limited access include intellectual property concerns (e.g., ML model 148 constitutes the intellectual property of an entity unwilling to share it), data privacy concerns (e.g., allowing access to ML model 148 risks confidential training data being leaked to an adversary), technical feasibility concerns (e.g., ML model 148 cannot be sufficiently reproduced due to unknown environment configures, seed values, etc.), technical viability concerns (e.g., using ML model 148 for generating new predictions can be slow or expensive), adversarial behavior concerns (e.g., the owner of ML model 148 does not want ML model explanations to be provided to outside persons/entities), deletion (e.g., ML model 148 has been deleted by the developer, owner, etc. and the owner of ML model 148 does not want instances of ML model 148 proliferating), and/or the like.

Explanation compute device 100 can be used to generate a ML model explanation for ML model 148, even without having access to ML model 148. Explanation compute device 100 can be any type of device, such as a server, desktop, laptop, mobile device, internet of things device, and/or the like.

The processor 102 of explanation compute device 100 can be, for example, a hardware based integrated circuit (IC), or any other suitable processing device configured to run and/or execute a set of instructions or code. For example, the processor 102 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 102 can be configured to run any of the methods and/or portions of methods discussed herein.

The memory 104 of the explanation compute device 100 can be, for example, a random-access memory (RAM), a memory buffer, a hard drive, a read-only memory (ROM), an erasable programmable read-only memory (EPROM), and/or the like. In some instances, the memory 104 can store, for example, one or more software programs and/or code that can include instructions to cause the processor 102 to perform one or more processes, functions, and/or the like. In some implementations, the memory 104 can include extendable storage units that can be added and used incrementally. In some implementations, the memory 104 can be a portable memory (e.g., a flash drive, a portable hard disk, and/or the like) that can be operatively coupled to the processor 142. In some instances, the memory 104 can be remotely operatively coupled with a compute device (not shown); for example, a remote database device can serve as a memory and be operatively coupled to the explanation compute device 140.

The memory 104 can store a representation of a set of explicands 108. In some implementations, an explicand refers to an input(s) for which an ML explanation is to be provided. Said differently, an ML explanation is to be provided for the explicand. For example, an explicand could be “What movies do you recommend I watch,” where a user desires an explanation for how ML model 148 would determine the recommended movies. The set of explicands 108 can include a single explicand, or a plurality of explicands. If the set of explicands 108 includes a single explicand, an explanation can be provided for that single explicand. If the set of explicands 108 includes multiple explicands, one or more explanations (e.g., a single explanation or multiple explanations) can be provided for the multiple explicands and/or one or more explanations (e.g., a single explanation or multiple explanations) can be provide for a subset of explicands included in the multiple explicands.

The memory 104 also stores representations of subset of inputs 112 and subset of outputs 114. The subset of inputs 112 and subset of outputs 114 can be used to generate the explanation 110 (e.g., using fit weighted linear regression). Explanation 110 can explain how ML model 148 calculates outputs for the set of explicands 108. Explanation 110 can indicate, for example, coefficients/weights for features attributed to explicands from the set of explicands 108 when calculating an output. If, for example, the explicand is “What movies do you recommend I watch.” explanation 110 can indicate that age has a 30% influences on the output, gender has a 15% influence on the output, previous watch history has a 40% influence on the output, and region has a 15% influence on the output.

In some implementations, explanation 110 includes indication of a recourse explanation. In some implementations, explanation 110 includes indication of a counterfactual explanation. In some implementations, explanation 110 includes indication of a contrastive explanation. In some implementations, explanation 110 includes indication of a prototype explanation. In some implementations, explanation 110 includes indication of or an anchor explanation.

Subset of inputs 112 and subset of outputs 114 can be generated in a variety of ways. For example, in some implementations, a set of synthetic inputs are generated based on the set of explicands 108. The set of synthetic inputs can be different than the set of inputs 146. In some implementations, the number of synthetic inputs in the set of synthetic inputs is less than the number of inputs in the set of inputs 146. For each synthetic input, an input from the set of inputs 146 most similar to that synthetic input in the feature space is identified to generate the subset of inputs 112. For each input from the subset of inputs 112 (or a minimum proportion of inputs form the subset of inputs 112, such as at least 50%, at least 75%, at least 90%, and/or the like), the output from the set of outputs 150 that was produced by ML model 148 in response to inputting that input is included in the subset of outputs 114. In some implementations, the number of synthetic inputs in the set of synthetic inputs is equal to the number of inputs in the subset of inputs 112 and the number of outputs in the subset of outputs 150. In some implementations, a feature space refers to the set of all possible values for a predetermined set of features from set of inputs 146, subset of inputs 112, set of outputs 150, and/or subset of outputs 114. For example, if the set of inputs 146 and set of outputs 150 include features color, shape, and orientation, the feature space can include various colors (e.g., red, blue, green, yellow, etc.), shapes (e.g., square, circle, triangle, start, etc.), and orientations (e.g., vertical, horizontal, etc.).

As another example, in some implementations, a set of synthetic inputs are generated based on the set of explicands 108. The set of synthetic inputs can be different than the set of inputs 146. In some implementations, the number of synthetic inputs in the set of synthetic inputs is less than the number of inputs in the set of inputs 146. For each synthetic input, an input from the set of inputs 146 most similar to that synthetic input in the feature space is identified to generate the subset of inputs 112. For each input from the subset of inputs 112 (or a minimum proportion of inputs form the subset of inputs 112, such as at least 50%, at least 75%, at least 90%, and/or the like), the output from the set of outputs 150 that was produced by ML model 148 in response to inputting that input is included in the subset of outputs 114. Instead of using subset of inputs 112 to generate explanation 110, however, the set of synthetic inputs and set of outputs 114 are used. The subset of inputs 112 serves to identify the subset of outputs 114. In some implementations, the number of synthetic inputs in the set of synthetic inputs is equal to the number of inputs in the subset of inputs 112 and the number of outputs in the subset of outputs 150.

As another example, in some implementations, subset of inputs 112 is generated by identifying inputs from the set of inputs that are most similar to the set of explicands 108 in feature space. For each input from subset of inputs 112, the output from the set of outputs 150 that was produced by ML model 148 in response to inputting that input is included in the subset of outputs 114.

In some implementations, if explanation 110 fails to satisfy one or more predetermined criteria (e.g., weights for features outside a predetermined acceptable range), a remedial action can occur. For example, if explanation 110 indicates that ML model 148 is biased, a signal can be sent (e.g., to ML compute device 140) to cause ML model 148 to be retrained, not used, and/or the like.

It is possible that ML model 148 will exhibit model drift and change over time (e.g., due to changes in data, relationships between input and output variables, and/or the like). In some implementations, an updated set of inputs 146, set of outputs 150, subset of inputs 112, and/or subset of outputs 114 can be received, used, calculated, and/or the like after a triggering event (e.g., model drift detected, a predetermined period of time has elapsed, etc.). In some implementations, even if there is model drift, set of inputs 146, set of outputs 150, subset of inputs 112, and/or subset of outputs 114 are still used to generate explanations; this allows ML compute device 140 and explanation compute device 100 to use less computational time and resources.

In some implementations, any number of explanations can be generated for any number of explicands using any number of subsets of inputs, subsets of outputs, sets of inputs, sets of outputs, or ML models. For example, explanations can be generated for multiple different ML models. In some implementations, multiple explanations are generated for a single model over a range of time, and the multiple explanations can be compared to determine if data drift exists (e.g., data drift if the explanations are substantially, such as more than 10%, more than 25%, and/or the like, different).

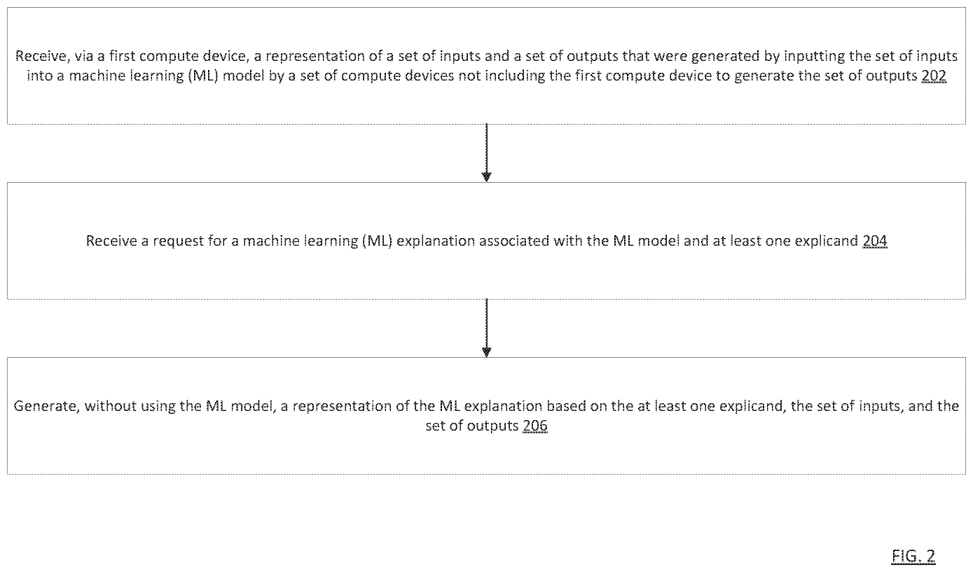

FIG. 2 shows a flowchart of a method 200 to generate an ML explanation for an ML model without using the ML model, according to an embodiment. In some implementations, method 200 is performed by a processor (e.g., processor 102).

At 202, a representation of a set of inputs (e.g., set of inputs 146) and a set of outputs (e.g., set of outputs 150) are received (e.g., from ML compute device 140) at a first compute device (e.g., explanation compute device 100). The set of inputs and the set of outputs were generated by inputting the set of inputs into an ML model by a set of compute devices not including the first compute device to generate the set of outputs. In some implementations, the first compute device does not have access to the ML model.

At 204, a request for an ML explanation (e.g., explanation 110) associated with the ML model and at least one explicand (e.g., set of explicands 108) is received. For example, the request could request an explanation for how the ML model calculates an output for the at least one explicand.

At 206, a representation of the ML explanation is generated without using the ML model and based on the at least one explicand, the set of inputs, and the set of outputs. In some implementations, the ML explanation includes an indication of at least one of a recourse explanation, a counterfactual explanation, a contrastive explanation, a prototype explanation, or an anchor explanation. In some implementations, 206 occurs automatically (e.g., without human intervention) in response to 204.

In some implementations of method 200, generating the ML explanation at 206 includes a sub-step of generating a set of synthetic inputs based on the at least one explicand. The set of synthetic inputs can be different than the set of inputs. Generating the ML explanation at 206 can further include a sub-step of identifying, for each synthetic input from the set of synthetic inputs and to generate a subset of inputs (e.g., subset of inputs 112), an input from the set of inputs most similar to that synthetic input in a feature space. Generating the ML explanation at 206 can further include a sub-step of identifying, for each input from the subset of inputs and to generate a subset of outputs (e.g., subset of outputs 114), an output from the set of outputs associated with that input. The ML explanation can then be generated using the set of synthetic inputs and the subset of outputs (e.g., but not the subset of inputs).

In some implementations of method 200, generating the ML explanation at 206 includes a sub-step of generating a set of synthetic inputs based on the at least one explicand. The set of synthetic inputs can be different than the set of inputs. Generating the ML explanation at 206 can further include a sub-step of identifying, for each synthetic input from the set of synthetic inputs and to generate a subset of inputs (e.g., subset of inputs 112), an input from the set of inputs most similar to that synthetic input in a feature space. Generating the ML explanation at 206 can further include a sub-step of identifying, for each input from the subset of inputs and to generate a subset of outputs (e.g., subset of outputs 114), an output from the set of outputs associated with that input. The ML explanation can then be generated using the subset of inputs and the subset of outputs (e.g., but not the set of synthetic inputs).

In some implementations of method 200, generating the ML explanation at 206 includes a sub-step of identifying a subset of inputs (e.g., subset of inputs 112) from the set of inputs most similar to the at least one explicand in a feature space. Generating the ML explanation at 206 can further include a sub-step of identifying a subset of outputs (e.g., subset of outputs 114) from the set of outputs associated with the subset of inputs. The ML explanation can then be generated using the subset of inputs and the subset of outputs.

In some implementations of method 200, the at least one explicand is a single explicand and the ML explanation includes an indication of local feature attribution associated with the single explicand. Said differently, the ML explanation indicates feature attributions for the single explicand and not other explicands. In some instances, local feature attribution refers to generating an explanation describing features for a single explicand (e.g., an explanation for how a single movie recommendation was calculated). In some implementations of method 200, the at least one explicand is a plurality of explicands and the ML explanation includes indication of global feature attribution associated with the plurality of explicands. In some instances, global feature attribution refers to generating an explanation describing features for a plurality of different explicands (e.g., an explanation for how multiple different movie recommendations were calculated), such as a subset of multiple explicands from a plurality of explicands or all explicands from a plurality of explicands.

In some implementations of method 200, the ML explanation is a first explanation and method 200 further includes calculating a set of metrics values for a set of metrics that represent a relationship between the first explanation and a second explanation that is generated using the ML model. The set of metrics can include a data drift metric and a sample count metric. If values for the set of metrics are outside a predetermined acceptable range, a remedial action can occur (e.g., cause ML model to be retrained or not used until retrained).

In some implementations of method 200, the set of inputs is a first set of inputs, the set of outputs is a first set of outputs, the request is a first request, the ML explanation is a first explanation, the explicand is a first explicand, and method 200 further includes receiving a representation of a second set of inputs and a second set of outputs that were generated by inputting the second set of inputs into the ML model by the set of compute devices not including the first compute device. In some implementations, method 200 further includes receiving a second request for a second explanation associated with the ML model and a second explicand. In some implementations, method 200 further includes generating, without using the ML model, a representation of the second explanation based on the second explicand, the second set of inputs, and the second set of outputs. In some implementations, method 200 further includes repeatedly checking (e.g., continuously, periodically, sporadically, etc.) for concept drift detection using a set of explanations that includes the first explanation and the second explanation.

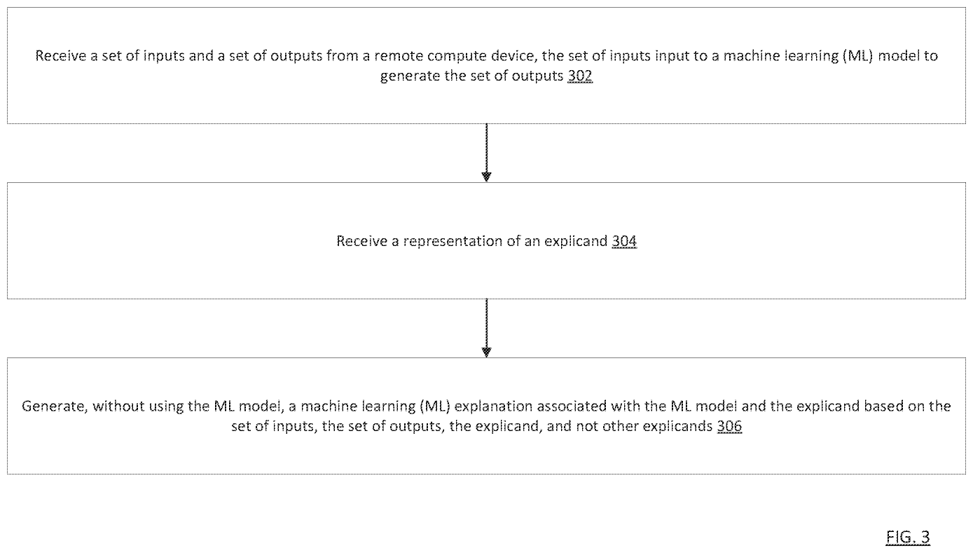

FIG. 3 shows a flowchart of a method 300 to generate an ML explanation for a ML model without using the ML model, according to an embodiment. In some implementations, method 300 is performed by a processor (e.g., processor 102).

At 302, a set of inputs (e.g., set of inputs 146) and a set of outputs (e.g., set of outputs 150) are received from a remote compute device (e.g., ML compute device 140). The set of inputs were input to an ML model (e.g., ML model 148) to generate the set of outputs.

At 304, a representation of an explicand (e.g., set of explicands 108) is received. The explicand is a single explicand (i.e., not multiple explicands).

At 306, an ML explanation (e.g., explanation 110) associated with the ML model and the explicand is generated without using the ML model and based on the set of inputs, the set of outputs, the explicand, and not other explicands. In some implementations, 306 occurs automatically (e.g., without human intervention) in response to 304.

In some implementations of method 300, generating the ML explanation at 306 includes a sub-step of generating a set of synthetic inputs based on the explicand. The set of synthetic inputs can be different than the set of inputs. Generating the ML explanation at 306 can further include a sub-step of identifying, for each synthetic input from the set of synthetic inputs and to generate a subset of inputs (e.g. subset of inputs 112), an input from the set of inputs most similar to that synthetic input in a feature space. Generating the ML explanation at 306 can further include a sub-step of identifying, for each input from the subset of inputs and to generate a subset of outputs (e.g. subset of outputs 150), an output from the set of outputs associated with that input. The ML explanation can then be generated using the set of synthetic inputs and the subset of outputs (e.g., and not the subset of inputs).

In some implementations of method 300, generating the ML explanation at 306 includes a sub-step of generating a set of synthetic inputs based on the explicand. The set of synthetic inputs can be different than the set of inputs. Generating the ML explanation at 306 can further include a sub-step of identifying, for each synthetic input from the set of synthetic inputs and to generate a subset of inputs (e.g., subset of inputs 112), an input from the set of inputs most similar to that synthetic input in a feature space. Generating the ML explanation at 306 can further include a sub-step of identifying, for each input from the subset of inputs and to generate a subset of outputs (e.g. subset of outputs 114), an output from the set of outputs associated with that input. The ML explanation can be generated using the subset of inputs and the subset of outputs (e.g., and not the set of synthetic inputs).

In some implementations of method 300, generating the ML explanation at 306 includes a sub-step of identifying a subset of inputs (e.g., subset of inputs 112) from the set of inputs most similar to the explicand in a feature space. Generating the ML explanation at 306 can further include a sub-step of identifying a subset of outputs (e.g., subset of outputs 114) from the set of outputs associated with the subset of inputs. The ML explanation generated using the subset of inputs and the subset of outputs.

In some implementations of method 300, the ML explanation is a first explanation and method 300 further includes generating, without using the ML model, a second explanation associated with the ML model and a plurality of explicands that includes the explicand based on the set of inputs, the set of outputs, and the plurality of explicands.

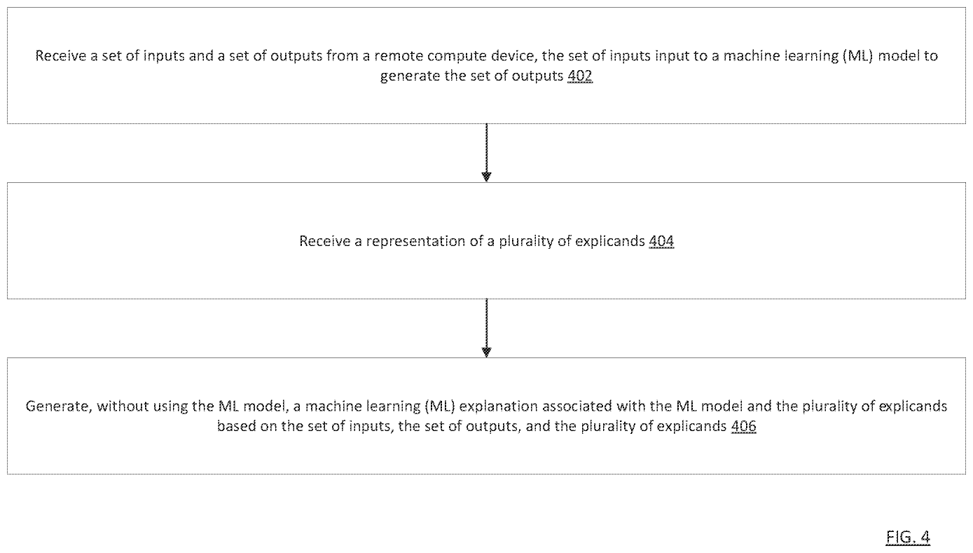

FIG. 4 shows a flowchart of a method 400 to generate an ML explanation for a ML model without using the ML model, according to an embodiment. In some implementations, method 400 is performed by a processor (e.g., processor 102).

At 402, a set of inputs (e.g., set of inputs 146) and a set of outputs (e.g., set of outputs 150) are received from a remote compute device (e.g., ML compute device 140). The set of inputs were input to an ML model (e.g., ML model 148) to generate the set of outputs.

At 404, a representation of a plurality of explicands (e.g., set of explicands 108) are received. The plurality of explicands can include explicands that are all different, explicands that are all the same, or a combination of similar and different explicands.

At 406, an ML explanation (e.g. explanation 110) associated with the ML model and the plurality of explicands is generated without using the ML model and based on the set of inputs, the set of outputs, and the plurality of explicands. In some implementations, 406 occurs automatically (e.g., without human intervention) in response to 404.

In some implementations of method 400, the ML explanation is a first explanation and method 400 further includes generating, without using the ML model, a second explanation associated with the ML model and a subset of explicands from the plurality of explicands based on the set of inputs, the set of outputs, and the subset of explicands.

In some implementations of method 400, the ML explanation is a first explanation and method 400 further includes generating, for each explicand from the plurality of explicands and without using the ML model, a second explanation associated with the ML model and that explicand based on the set of inputs, the set of outputs, and that explicand.

In some implementations of method 400, the set of inputs is a first set of inputs, the set of outputs is a first set of outputs, the remote compute device is a first remote compute device, the ML model is a first ML model, the plurality of explicands is a first plurality of explicands, and method 400 further includes receiving a second set of inputs and a second set of outputs from a second remote compute device. The second set of inputs can be input to a second ML model to generate the second set of outputs. Some implementations of method 400 further include receiving a representation of a second plurality of explicands. Some implementations of method 400 further include generating, without using the first ML model and the second ML model, an explanation associated with the second ML model and the second plurality of explicands based on the second set of inputs, the second set of outputs, and the second plurality of explicands.

It should be understood that the disclosed embodiments are not intended to be exhaustive, and functional, logical, operational, organizational, structural and/or topological modifications may be made without departing from the scope of the disclosure. As such, all examples and/or embodiments are deemed to be non-limiting throughout this disclosure.

All definitions, as defined and used herein, should be understood to control over dictionary definitions, definitions in documents incorporated by reference, and/or ordinary meanings of the defined terms.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either.” “one of.” “only one of.” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising.” “including.” “carrying,” “having,” “containing.” “involving,” “holding.” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

1. A method, comprising
receiving, via a processor of a first compute device, a representation of a set of inputs and a set of outputs that were generated by inputting the set of inputs into a machine learning (ML) model by a set of compute devices not including the first compute device to generate the set of outputs;
receiving, via the processor, a request for a machine learning (ML) explanation associated with the ML model and at least one explicand; and
generating, via the processor and without using the ML model, a representation of the ML explanation based on the at least one explicand, the set of inputs, and the set of outputs.

2. The method of claim 1, wherein generating the ML explanation includes:
generating, via the processor, a set of synthetic inputs based on the at least one explicand, the set of synthetic inputs different than the set of inputs;
identifying, via the processor, for each synthetic input from the set of synthetic inputs, and to generate a subset of inputs, an input from the set of inputs most similar to that synthetic input in a feature space; and
identifying, via the processor, for each input from the subset of inputs, and to generate a subset of outputs, an output from the set of outputs associated with that input, the ML explanation generated using the set of synthetic inputs and the subset of outputs.

3. The method of claim 1, wherein generating the ML explanation includes:
generating, via the processor, a set of synthetic inputs based on the at least one explicand, the set of synthetic inputs different than the set of inputs;
identifying, via the processor, for each synthetic input from the set of synthetic inputs, and to generate a subset of inputs, an input from the set of inputs most similar to that synthetic input in a feature space; and
identifying, via the processor, for each input from the subset of inputs, and to generate a subset of outputs, an output from the set of outputs associated with that input, the ML explanation generated using the subset of inputs and the subset of outputs.

4. The method of claim 1, wherein generating the ML explanation includes:
identifying, via the processor, a subset of inputs from the set of inputs most similar to the at least one explicand in a feature space; and
identifying, via the processor, a subset of outputs from the set of outputs associated with the subset of inputs, the ML explanation generated using the subset of inputs and the subset of outputs.

5. The method of claim 1, wherein the first compute device does not have access to the ML model.

6. The method of claim 1, wherein the at least one explicand is a single explicand and the ML explanation includes an indication of local feature attribution associated with the single explicand.

7. The method of claim 1, wherein the at least one explicand is a plurality of explicands and the ML explanation includes indication of global feature attribution associated with the plurality of explicands.

8. The method of claim 1, wherein the ML explanation includes an indication of at least one of a recourse explanation, a counterfactual explanation, a contrastive explanation, a prototype explanation, or an anchor explanation.

9. The method of claim 1, wherein the ML explanation is a first explanation and the method further comprises:
calculating, via the processor, a set of metrics values for a set of metrics that represent a relationship between the first explanation and a second explanation that is generated using the ML model, the set of metrics including a data drift metric and a sample count metric.

10. The method of claim 1, wherein the set of inputs is a first set of inputs, the set of outputs is a first set of outputs, the request is a first request, the ML explanation is a first explanation, the explicand is a first explicand, and the method further comprises:
receiving, via the processor, a representation of a second set of inputs and a second set of outputs that were generated by inputting the second set of inputs into the ML model by the set of compute devices not including the first compute device;
receiving, via the processor, a second request for a second explanation associated with the ML model and a second explicand; and
generating, via the processor and without using the ML model, a representation of the second explanation based on the second explicand, the second set of inputs, and the second set of outputs.

11. The method of claim 10, further comprising:
repeatedly checking, via the processor, for concept drift detection using a set of explanations that includes the first explanation and the second explanation.

12. An apparatus, comprising:
a memory; and
a processor operatively coupled to the memory, the processor configured to:
receive a set of inputs and a set of outputs from a remote compute device, the set of inputs input to a machine learning (ML) model to generate the set of outputs;
receive a representation of an explicand; and
generate, without using the ML model, a machine learning (ML) explanation associated with the ML model and the explicand based on the set of inputs, the set of outputs, the explicand, and not other explicands.

13. The apparatus of claim 12, wherein generating the ML explanation includes:
generating a set of synthetic inputs based on the explicand, the set of synthetic inputs different than the set of inputs;
identifying, for each synthetic input from the set of synthetic inputs and to generate a subset of inputs, an input from the set of inputs most similar to that synthetic input in a feature space; and
identifying, for each input from the subset of inputs and to generate a subset of outputs, an output from the set of outputs associated with that input, the ML explanation generated using the set of synthetic inputs and the subset of outputs.

14. The apparatus of claim 12, wherein generating the ML explanation includes:
generating a set of synthetic inputs based on the explicand, the set of synthetic inputs different than the set of inputs;
identifying, for each synthetic input from the set of synthetic inputs and to generate a subset of inputs, an input from the set of inputs most similar to that synthetic input in a feature space; and
identifying, for each input from the subset of inputs and to generate a subset of outputs, an output from the set of outputs associated with that input, the ML explanation generated using the subset of inputs and the subset of outputs.

15. The apparatus of claim 12, wherein generating the ML explanation includes:
identifying a subset of inputs from the set of inputs most similar to the explicand in a feature space; and
identifying a subset of outputs from the set of outputs associated with the subset of inputs, the ML explanation generated using the subset of inputs and the subset of outputs.

16. The apparatus of claim 12, wherein the ML explanation is a first explanation, and the processor is further configured to:
generate, without using the ML model, a second explanation associated with the ML model and a plurality of explicands that includes the explicand based on the set of inputs, the set of outputs, and the plurality of explicands.

17. A machine-readable medium storing code representing instructions to be executed by a processor, the code comprising code to cause the processor to:
receive a set of inputs and a set of outputs from a remote compute device, the set of inputs input to a machine learning (ML) model to generate the set of outputs;
receive a representation of a plurality of explicands; and
generate, without using the ML model, a machine learning (ML) explanation associated with the ML model and the plurality of explicands based on the set of inputs, the set of outputs, and the plurality of explicands.

18. The non-transitory processor-readable medium of claim 17, wherein the ML explanation is a first explanation and the code further comprises code to cause the processor to:
generate, without using the ML model, a second explanation associated with the ML model and a subset of explicands from the plurality of explicands based on the set of inputs, the set of outputs, and the subset of explicands.

19. The non-transitory processor-readable medium of claim 17, wherein the ML explanation is a first explanation and the code further comprises code to cause the processor to:
generate, for each explicand from the plurality of explicands and without using the ML model, a second explanation associated with the ML model and that explicand based on the set of inputs, the set of outputs, and that explicand.

20. The non-transitory processor-readable medium of claim 17, wherein the set of inputs is a first set of inputs, the set of outputs is a first set of outputs, the remote compute device is a first remote compute device, the ML model is a first ML model, the plurality of explicands is a first plurality of explicands, and the code further comprises code to cause the processor to:
receive a second set of inputs and a second set of outputs from a second remote compute device, the second set of inputs input to a second ML model to generate the second set of outputs;
receive a representation of a second plurality of explicands; and
generate, without using the first ML model and the second ML model, an explanation associated with the second ML model and the second plurality of explicands based on the second set of inputs, the second set of outputs, and the second plurality of explicands.
